(19) United States
(12) Patent Application Publication
(10) Pub. No.: US 2019/0112756 A1
(43) Pub. Date: Apr. 18, 2019

(54) WATER PERMEABLE ARTIFICIAL TURF AND METHOD OF MAKING SAME

(71) Applicant: Textile Rubber and Chemical Company, Inc., Dalton, GA (US)

(72) Inventors: Larry E. Mashburn, Dalton, GA (US); Giuseppe V. Tambasco, Marietta, GA (US)

(21) Appl. No.: 16/229,588

(22) Filed: Dec. 21, 2018

Related U.S. Application Data
(63) Continuation-in-part of application No. 15/340,616, filed on Nov. 1, 2016, now Pat. No. 10,202,722.

(51) Int. Cl. D06N 7/00; E01C 13/08; D05C 17/02

(52) U.S. Cl. CPC D06N 7/0073; D06N 7/0076; D06N 7/0036; E01C 13/08; B32B 2037/1238; D06N 2205/023; D06N 2205/045; D06N 2205/106; D10B 2505/202; D05C 17/02

(57) ABSTRACT

The invention comprises a method. The method comprises applying to a primary backing and loop backs of a tufted synthetic turf a plurality of solid polymer particles having a particle size less than or equal to 1,000 microns such that a layer of solid polymer particles is formed across the width and length of the primary backing, wherein the polymer particles are applied to the primary backing at a rate of approximately 5 to approximately 18 ounces of polymer per square yard and wherein the solid polymer particles are thermoplastic polymer particles or a mixture of thermoplastic polymer particles and thermosetting polymer particles. The method also comprises heating the polymer particles on the primary backing and loop backs to a temperature at or above the melting temperature of the polymer particles and allowing the heated polymer particles to cool below their melting temperature wherein the tufted synthetic turf has bundle lock of at least 6.8 pounds and the tufted synthetic turf has a water permeability of at least 10 inches of water per hour.

### CROSS-REFERENCE TO RELATED APPLICATIONS

This application is a continuation-in-part of application Ser. No. 15/340,616 filed Nov. 1, 2016.

### FIELD OF THE INVENTION

The present invention generally relates to artificial turf. More particularly, the present invention relates to a water permeable artificial turf and to a method of making a water permeable artificial turf. The present invention also relates to a novel coating/adhesive application system. More particularly, the present invention relates to a method for securing tufted filaments, strips, strands, ribbons or filament bundles in a primary backing. The present invention also relates to a water permeable polymer precoat for synthetic turf. The present invention also relates to an improved synthetic turf.

### BACKGROUND OF THE INVENTION

Synthetic turf is typically constructed from a primary backing material and a face pile formed on one side. Face pile can be formed in the primary backing by tufting a yarn in the primary backing. Currently, the majority of synthetic turf manufactured in the U.S. is made by a tufting process. The tufting process forms cut pile on one side of a primary backing and loop backs on the opposite side by a process well known in the art. The primary backing can be made from a woven or nonwoven fabric of synthetic materials, but the majority of primary backing currently being made in the U.S. to make artificial turf is made from woven flat ribbons of polypropylene. Typically, the primary backing of a synthetic turf is tufted with multiple strands that form a tufted fiber bundle.

After the primary backing is tufted, an adhesive precoat may be applied to lock or bind the tuft bundles in the primary backing. Typically, the adhesive precoat is a thermoset polyurethane polymer or an aqueous polymer dispersion, such as a styrene butadiene aqueous polymer dispersion. The thermoset polyurethane polymer or aqueous polymer dispersion-coated primary backing is then heated to initiate polyurethane polymerization or to remove the water from the aqueous polymer dispersion such that the polymer locks or binds the tuft loops in the primary backing. Then, a secondary backing may optionally be adhesively attached by applying a coating of adhesive on the side of the primary backing opposite the face pile. Such adhesive is typically a polyurethane, a latex or a hot melt adhesive. Then, a secondary backing is brought into intimate contact with the polymerizing polyurethane, uncured latex or the molten hot melt adhesive. The adhesive is then allowed to cool or cure, thereby adhesively attaching the secondary backing to the tufted primary backing.

One problem associated with synthetic turf is water drainage. One method known to improve water drainage is the physical create holes in the backing and polymer coating on the back surface of the backing. Another method is disclosed in U.S. Pat. No. 6,723,412. This patent discloses using spaced rows of adhesive to secure the parallel rows of synthetic ribbons that form the face pile in the backing material. Since the rows of adhesive are spaced from each other, the intermediate portions of the backing material are uncoated with adhesive, thereby allowing water to drain through the uncoated portions of the backing material. However, this method requires expensive and complex equipment to selectively apply to polymer to the backing in spaced rows.

It would be desirable to both achieve bundle lock and filament bind in a tufted primary backing of a synthetic turf using an adhesive system applied to substantially the entire length and width of the tufted backing material. It would also be desirable to achieve bundle lock and filament bind using reduced amounts of adhesive without sacrificing desired physical properties of the finished product. Additionally, it would also be desirable to both achieve bundle lock, filament bind using an adhesive system that also provides a water permeable polymer coating on the primary backing.

### SUMMARY OF THE INVENTION

The present invention satisfies the foregoing needs by providing an improved synthetic turf.

In one disclosed embodiment, the present invention comprises a method. The method comprises applying to a primary backing and loop backs of a tufted synthetic turf a plurality of solid polymer particles having a particle size of less than or equal to 1,000 microns such that a layer of solid polymer particles is formed across the width and length of the primary backing, wherein the polymer particles are applied to the primary backing at a rate of approximately 5 to approximately 18 ounces of polymer per square yard and wherein the solid polymer particles are thermoplastic polymer particles or a mixture of thermoplastic polymer particles and thermosetting polymer particles. The method also comprises heating the polymer particles on the primary backing and loop backs to a temperature at or above the melting temperature of the polymer particles and allowing the heated polymer particles to cool below their melting temperature wherein the tufted synthetic turf has bundle lock of at least 6.8 pounds and the tufted synthetic turf has a water permeability of at least 10 inches of water per hour.

In one disclosed embodiment, the present invention comprises a method. The method comprises applying a quantity of an aqueous dispersion of thermoplastic polymer particles to a primary backing and loop backs of a tufted carpet or a tufted synthetic turf, wherein the thermoplastic particles have an average particle size less than or equal to 1,000 microns. The method also comprises heating the aqueous dispersion to a temperature sufficient to remove water therefrom, and heating the thermoplastic particles on the primary backing and loop backs to a temperature at or above the melting temperature of the thermoplastic particles. The method further comprises allowing the heated thermoplastic polymer particles to cool below their melting temperature whereby the loop backs are adhered to the primary backing.

In another disclosed embodiment, the present invention comprises a method. The method comprises applying a composition to a tufted primary backing material, wherein the primary backing material has a first primary surface and a second primary surface, wherein tufts extend outwardly from the first primary surface and loop backs are formed on the second primary surface, and wherein the composition is applied to the loop backs and second primary surface of the tufted primary backing material. The composition comprises an aqueous dispersion of colloidal thermosetting polymer particles or colloidal thermoplastic polymer particles and thermoplastic polymer particles dispersed in the water, wherein the thermoplastic polymer particles have an average particle size of approximately 200 micron to approximately 1,000 microns. The method further comprises heating the tufted primary backing material and composition to remove water therefrom.

In another disclosed embodiment, the present invention comprises a method of making synthetic turf. The method comprises applying a plurality of solid polyethylene polymer particles to a first primary surface of a tufted primary backing to form a coating thereon, wherein the solid polyethylene polymer particles have an average particle size of approximately 1 to approximately 1,000 microns and a melt index of approximately 50 to approximately 500 grams/10 minutes at 190° C. at a weight of 2.16 kg. and wherein the primary backing is tufted with a plurality of synthetic filaments to form a plurality of synthetic filaments extending outwardly from the side of the synthetic turf opposite the primary backing. The method also comprises heating the solid polyethylene particles to a temperature above their melting point so that the solid polyethylene polymer particles melt and at least partially flow into the primary backing.

Accordingly, it is an object of the present invention to provide an improved synthetic turf.

Another object of the present invention is to provide a tufted synthetic turf that is water permeable while still having acceptable tuft bind properties.

Another object of the present invention is to provide a synthetic turf that requires the use relatively smaller amounts of adhesive.

A further object of the present invention is to provide a synthetic turf that does not sacrifice desired physical properties of the finished product.

Another object of the present invention is to provide a method of making a synthetic turf that utilizes an aqueous dispersion of thermoplastic particles.

Yet another object of the present invention is to provide an improved system for attaching a secondary backing to a primary backing of a synthetic turf.

A further object of the present invention is to provide an improved system for securing tuft loop backs to a primary backing of a tufted synthetic turf.

Another object of the present invention is to make a tufted synthetic turf that utilizes applying solid polymer particles to the primary backing and tuft loop backs.

A further object of the present invention is to provide an improved adhesive system for providing bundle lock and filament bind of a tufted pile in primary backing of a tufted synthetic turf.

Yet another object of the present invention is to provide an adhesive system for tufted synthetic turf that provides a water permeable polymer coating on the primary backing.

These and other objects, features and advantages of the present invention will become apparent after a review of the following detailed description of the disclosed embodiments and the appended drawing and claims.

### BRIEF DESCRIPTION OF THE DRAWINGS

FIG. 1 is a schematic view of a disclosed embodiment of an apparatus for preparing synthetic turf using the adhesive system of the present invention.

FIG. 2 is a cross-sectional side view of a tufted synthetic turf.

FIG. 3 is a schematic view of another disclosed embodiment of an apparatus for preparing synthetic turf using the adhesive system of the present invention.

FIG. 4 is a schematic view of another disclosed embodiment of an apparatus for preparing synthetic turf using the adhesive system of the present invention.

FIG. 5 is a schematic view of another disclosed embodiment of an apparatus for preparing synthetic turf using the adhesive system of the present invention.

### DETAILED DESCRIPTION OF THE DISCLOSED EMBODIMENTS

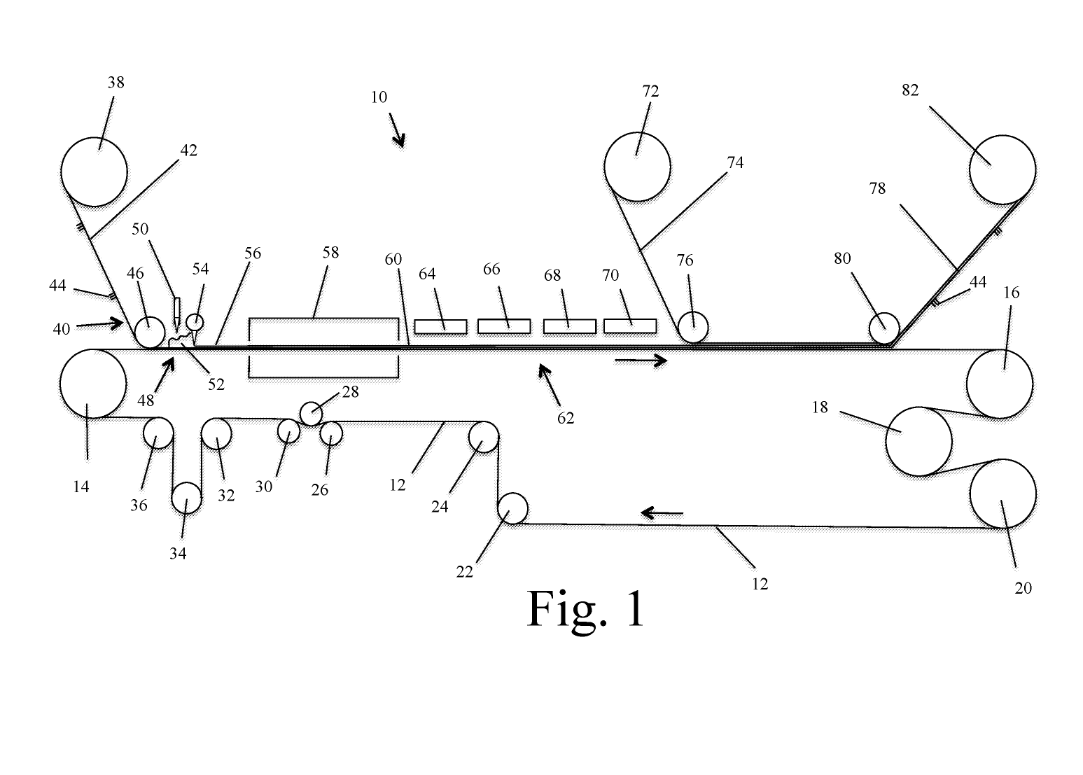

Referring now to the drawing in which like numbers indicate like elements throughout the several views, there is shown in FIG. 1 a disclosed embodiment of an apparatus 10 for forming a polymer coating on the primary backing of a synthetic turf in accordance with the present invention. The apparatus 10 comprises an endless conveyor belt 12 extending along and endless conveyor path over four drive rollers 14, 16, 18 and 20, which are driven by an electric motor (not shown), idler rollers 22, 24, belt guide rollers 26, 28, 30 and belt tensioner rollers 32, 34 and 36. The speed of the belt 12 is variably controllable to adjust to varying manufacturing needs.

From the drive roller 14, the conveyor belt 12, which preferably is constructed from Teflon coated fiberglass, is seen to pass around the drive rollers 16, 18, 20. The belt 12 is delivered to the idler rollers 22, 24, to the belt guide rollers 26, 28, 30, the belt tensioner 32, 34, 36 and then back to the drive roller 14. While the present disclosed embodiment is illustrated as using a conveyor belt system, the present invention can also be practiced using a tentered system.

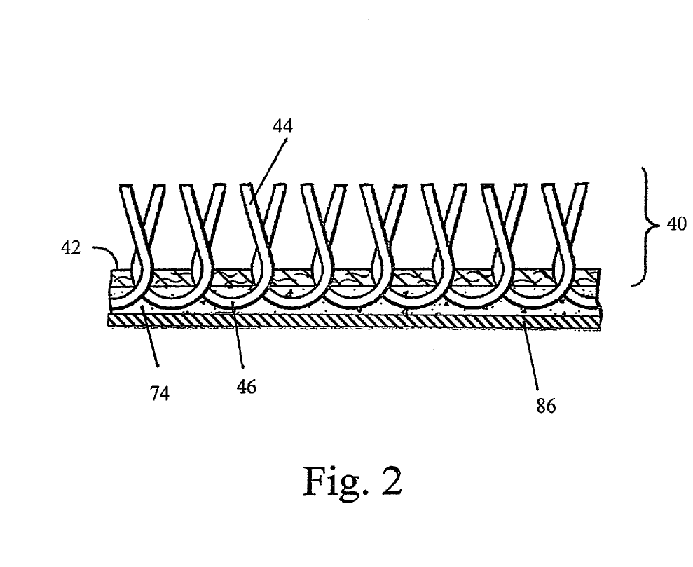

Positioned above the belt 12 adjacent the drive roller 14 is a supply roll 38 of tufted greige goods 40 (FIG. 2). The tufted greige goods 40 comprise a primary backing material 42 and tufted filaments, strips, strands, ribbons or filament bundles that form a face pile 44 simulating blades of grass on one side of the primary backing material and loop backs 46 on the other side of the primary backing material. The face pile 44 is shown in the disclosed embodiment as cut pile. However, the face pile 44 useful in the present invention can also be cut pile. In addition, the primary backing material 42 is shown as being tufted. However, face pile useful in the present invention can also be formed on one side of the primary backing material 42 in any way known in the art. The primary backing material 42 can be woven or nonwoven. Both the face pile 44 and the primary backing material 42 can be made from natural or synthetic materials. Furthermore, the face pile 44 and primary backing material 42 can be made from the same material or different materials. However, it is particularly preferred that the face pile 44 and the primary backing material 42 both be made from thermoplastic material. Suitable thermoplastic materials for the face pile 44 and primary backing material 42 include, but are not limited to, nylon, including polyadipamide, polycaprolactam, copolymers, and blends thereof; polyolefin, including polyethylene, polypropylene, copolymers and blends thereof; thermoplastic polyester, including polytrimethyleneterephthlate and polyethyleneterephthalate, and blends thereof; acrylics, including polyacrylonitrile; co-polymers and blends thereof. A large amount of the synthetic turf made in the U.S. is made from a primary backing made of woven flat ribbons of polypropylene and tufted with multiple stands forming tuft bundles, wherein the strands are also made from polypropylene.

The tufted greige goods 40 is fed from the supply roll 38, around a roller 46 and onto the belt 12 where it lays flat on the surface of the belt and moves in unison with the belt. As can be seen in FIG. 1, the tufted greige goods 40 is positioned so that the face pile 44 extends downwardly from the primary backing material 42 so that the face pile is adjacent to and contacts the belt 12 and the side of the primary backing material including the tuft loop backs 46 (FIG. 2) faces upward. The tufted greige goods 40 on the belt 12 moves from the roller 46 to a polymer deposition station 48. In the disclosed embodiment shown in FIG. 1, the polymer deposition station 48 includes a traversing downwardly extending spout 50 disposed above the tufted greige goods 40 on the belt 12. An aqueous dispersion of thermoplastic polymer particles is delivered into a mixer/frothing machine (not shown) where the aqueous dispersion is made into a frothed foam. While the present invention has been disclosed as preparing a foam using a frothing machine, it is specifically contemplated that a foam of the aqueous dispersion of thermoplastic polymer particles can be prepared by any method known in the art, including incorporating a blowing agent in the aqueous dispersion composition. The aqueous dispersion foam is transferred from the mixer/frothing machine through a flexible hose (not shown) to the spout 50. The spout 50 traverses back and forth across the width of the tufted greige goods 40 on the belt 12 while the polymer foam is dispensed from the spout onto the primary backing material 42. The aqueous dispersion foam forms a puddle 52 on the upper surface of the primary backing material 42. As the aqueous dispersion foam-bearing tufted greige goods 40 moves with the belt 12, it passes under a doctor bar 54 which transforms the puddle of aqueous dispersion foam 52 into a layer 56 of uniform thickness across the width of the primary backing material 42 of the tufted greige goods 40. The doctor bar 54 is set to a height so that the foam puddle 52 is transformed into a layer 56 of a thickness so that sufficient thermoplastic polymer particles are applied to the primary backing material 42 so that sufficient tuft lock is achieved for the loop backs 46 in the primary backing material and sufficient bond strength is provided so that a secondary backing material can be attached to a primary backing material. Preferably, the doctor bar 54 is set to a height so that the foam is formed into a layer of a thickness so that approximately 5 ounces per square yard to approximately 18 ounces per square yard of polymer are applied to the primary backing material 42 and loop backs 46, more preferably approximately 8 ounces per square yard to approximately 18 ounces per square yard, most preferably approximately 8 ounces per square yard to approximately 13 ounces per square yard, especially preferably approximately 5 ounces per square yard to approximately 13 ounces per square yard, more especially approximately 5 ounces per square yard to approximately 8 ounces per square yard. All of the foregoing ranges of polymer applied to the primary backing 42 include all of the intermediate values. It is particularly unexpected that the lower end of the foregoing ranges, such as approximately 5 ounces per square yard to approximately 8 ounces per square yard, provide acceptable tuft bind or bundle lock and filament bind or filament slippage.

While the present embodiment has been disclosed as applying an aqueous dispersion foam to the primary backing material 42, it is specifically contemplated that the aqueous dispersion can also be applied to the primary backing material 42 as a liquid dispersion of thermoplastic particles; i.e., in a non-foamed state.

The aqueous dispersion of thermoplastic particles comprises water, thermoplastic particles and a dispersing agent. The aqueous dispersion of thermoplastic particles contains approximately 5% to approximately 90% by weight solids, preferably approximately 30% to approximately 70% by weight solids. The aqueous dispersion of thermoplastic particles preferably comprises approximately 50% to approximately 90% by weight water, approximately 40% to approximately 70% by weight thermoplastic polymer particles and approximately 0.1% to approximately 10% by weight dispersion agent. The aqueous dispersion of thermoplastic particles more preferably comprises approximately 60% to approximately 80% by weight water, approximately 20% to approximately 40% by weight thermoplastic polymer particles and approximately 3% to approximately 5% by weight dispersion agent. The aqueous dispersion of thermoplastic particles most preferably comprises approximately 65% to approximately 67% by weight water, approximately 30% by weight thermoplastic polymer particles and approximately 3% to approximately 5% by weight dispersion agent. If the aqueous dispersion of thermoplastic particles is to be made into a foam, the composition can additionally include a foaming agent, preferably approximately 0.5% to approximately 5% by weight foaming agent, more preferably approximately 1% to approximately 2% by weight foaming agent, most preferably approximately 1% by weight foaming agent.

Suitable dispersion agents are those typically used to make aqueous dispersions from solid, non-soluble particles of the sizes set forth above and include, but are not limited to guar gum, agar gum and xanthan gum. Suitable foaming agents are those typically used in the carpet industry and include, but are not limited to, sodium lauryl sulfate and sodium lauryl ether sulfate.

The aqueous dispersion of thermoplastic particles can optionally include one or more of the following additional ingredients: a plasticizer, a thickener, a lubricant, a wetting agent, a colorant, a fire retardant and an inert filler. These additives generally are added to the aqueous dispersion at the rates shown in Table 1 below.

TABLE 1

| Ingredient | % by Weight |
|---|---|
| Plasticizers | 3% to 5% |
| Foaming agent | 0.1% to 2% |
| Thickeners | 0.1% to 2% |
| Lubricants | 0.1% to 2% |
| Wetting agents | 0.1% to 2% |
| Colorants | 0.05% to 0.1% |
| Fire retardants | 0.05% to 0.1% |
| Fillers | 10% to 50% |

The thermoplastic polymer particles in the aqueous dispersion are of a particles size such that when mixed with water and a dispersion agent, as specified above, form a stable aqueous dispersion of thermoplastic polymer particles. The thermoplastic polymer particles preferably have an average particles size of less than or equal to 1,000 microns, more preferably approximately 1 micron to 1,000 microns, most preferably approximately 10 micron to 1,000 microns, especially approximately 1 micron to approximately 100 microns, more especially approximately 10 microns to approximately 100 microns, most especially approximately 1 micron to approximately 80 microns. The polymer particles can be ground from polymer pellets to the desired particle sizes using methods known in the art including, but not limited to, a pulverizer or a hammer mill.

The thermoplastic polymer particles can be made from any thermoplastic polymer that can be used in carpet or synthetic turf. Preferred thermoplastic polymers include, but are not limited to, nylons, polyethylene, polypropylene, polystyrene, poly(methyl methacrylate), poly(vinyl chloride), poly(vinyl acetate), polycarbonate, polycaprolactone, poly(ethylene oxide), poly(vinyl alcohol), poly(ethylene terephthalate), poly(ether sulphone), poly(butyl terephthalate), poly(ethyl methacrylate), ultrahigh molecular weight polyethylene. Particularly preferred polymers include nylon, including polyadipamide, polycaprolactam, copolymers, and blends thereof; polyolefin, including polyethylene, polypropylene, copolymers and blends thereof; thermoplastic polyester, including polytrimethyleneterephthlate and polyethyleneterephthalate, and blends thereof; acrylics, including polyacrylonitrile; co-polymers and blends thereof. The polymer particles may be amorphous, semi-crystalline or crystalline before they are heated. The process is applicable to single polymers and to mixtures of polymers. For example, the mixture may be of polymers of the same composition but of different molecular weight, or chemically different polymers.

The tufted primary backing material 42 bearing the layer 56 of foam of aqueous dispersion of thermoplastic polymer particles on the belt 12 moves from the polymer deposition station 48 to a heated air oven 58. While the aqueous dispersion of thermoplastic polymer particles is applied to the primary backing material 42 as a foam, it is preferred that the foam collapse relatively quickly after it is formed into a layer on the primary backing material. Preferably, the foam of the layer 56 will collapse somewhere between the doctor bar 54 and exiting the oven 58.

The heated air oven 58 is operated at a temperature sufficient to evaporate water from the foam of aqueous dispersion of thermoplastic polymer particles. Preferably, the heated air oven 58 is operated at a temperature sufficient to evaporate water from the foam of aqueous dispersion of thermoplastic polymer particles but below the melting temperature of the thermoplastic polymer particles. More preferably, the heated air oven 58 is operated at a temperature of approximately 212° F. (100° C.). Most preferably, the heated air oven 58 is operated at a temperature of approximately 212° F. to approximately 250° F., especially, approximately 212° F. to approximately 225° F.

The speed of the belt 12, the length of the oven 58 and the temperature of the oven are all designed so that the layer 56 of aqueous dispersion of thermoplastic polymer particles on the primary backing material 42 has a residence time in the oven such that the layer 56 is substantially dry when it leaves the oven. When the water is substantially removed from the aqueous dispersion of thermoplastic polymer particles, the result is a layer 60 of substantially dry thermoplastic polymer particles on the primary backing material 42. As used herein the term “substantially dry” means containing less than 5% by weight moisture.

The tufted primary backing material 42 bearing the layer 60 of substantially dry thermoplastic polymer particles moves with the belt 12 from the heated oven 58 to a thermoplastic polymer particle melting station 62. The thermoplastic polymer particle melting station 62 comprises a plurality of infrared heaters 64, 66, 68, 70 disposed above tufted primary backing material 42 bearing the layer 60 of substantially dry thermoplastic polymer particles on the belt 12. The infrared heaters 64-70 are of a strength and are positioned a distance from the primary backing material 42 so that the layer of substantially dry thermoplastic polymer particles on the primary backing material are heated to a temperature higher than when in the heated oven 58. The infrared heaters 64-70 are positioned a distance above the belt 12, the belt is at a speed and the infrared heaters are of a size such that the residence time of the tufted primary backing material 42 bearing the layer 60 of substantially dry thermoplastic polymer particles under the infrared heaters is such that the thermoplastic polymer particles are heated to a temperature equal to or higher than the melting point of the thermoplastic polymer particles. Preferably, the layer 60 of substantially dry thermoplastic polymer particles on the tufted primary backing material 42 is heated by the infrared heaters 62-68 to a temperature of approximately 212° F. to approximately 350° F., more preferably, approximately 212° F. to approximately 275° F. The objective of using the infrared heaters 64-70 is to convert the solid thermoplastic polymer particles that make up the substantially dry layer 60 to at least a mesophase between a solid and a liquid, and preferably, to a flowable material or a liquid.

Optionally, disposed above the belt 12 is a supply roll 72 of a secondary backing material 74. The secondary backing material 74 feeds from the supply roll 72 under a chilled press roller 76. The chilled roller 76 is a hollow roller into which cold water is circulated. As the tufted primary backing material 42 bearing the melted thermoplastic polymer particles moves from the thermoplastic polymer particle melting station 62 and passes under the chilled press roller 76, the secondary backing material 74 is pressed into intimate contact with the melted thermoplastic polymer particles on the tufted primary backing material 42. The pressure of the chilled press roller 76 on the primary backing material 42 and the secondary backing material 74 causes the melted thermoplastic polymer particles to flow into both the primary backing material and the secondary backing material. Then, the chilled press roller 76 cools the secondary backing material 74, which in turn removes heat from the melted thermoplastic polymer particles and causes them to solidify thereby securely attaching the secondary backing material to the primary backing material 42 and also securely anchoring the loop backs 46 in the primary backing material, which forms a laminated synthetic turf structure 78.

The secondary backing material 74 can be woven or nonwoven. The secondary backing material 74 can be made from natural or synthetic materials. Furthermore, the primary backing material 42 and the secondary backing material 74 can be made from the same material or different materials. However, it is particularly preferred that the face pile 44, the primary backing material 42 and the secondary backing material 74 are all made from thermoplastic polymer materials. Suitable thermoplastic polymer materials for the secondary backing material 74 include, but are not limited to, nylon, including polyadipamide, polycaprolactam, copolymers, and blends thereof; polyolefin, including polyethylene, polypropylene, copolymers and blends thereof; thermoplastic polyester, including polytrimethyleneterephthlate and polyethyleneterephthalate, and blends thereof; acrylics, including polyacrylonitrile; co-polymers and blends thereof.

It is an essential feature of the present invention that the primary backing material 42 and the secondary backing material 74 are water permeable. Water permeability is an inherent feature of backing materials that are woven or non-woven because they are not continuous materials, but, rather, have relatively large interstices through which water can pass. For this reason, a woven backing material is preferred for the primary backing material 42 and the secondary backing material 74.

The laminated synthetic turf structure 78 moves with the belt 12 from the chilled press roller 76 to a stripping roller 80 where the laminated carpet structure is removed from the belt and collected in a take up roll 82.

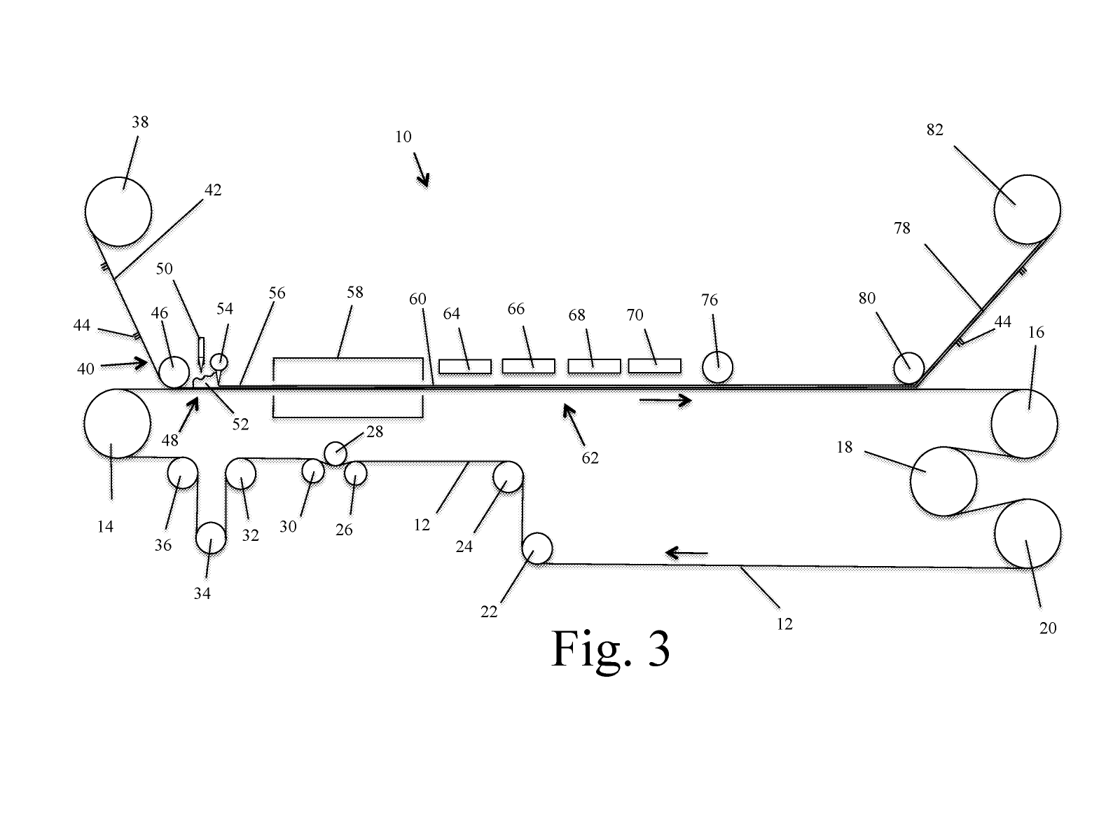

FIG. 3 shows an alternate disclosed embodiment of the present invention. The apparatus shown in FIG. 3 is identical to the apparatus shown in FIG. 1, except there is no secondary back involved. The processing of the synthetic turf in FIG. 3 is also identical to that shown in FIG. 1 up to the point where the coated primary backing 42 emerges from the heated oven 58 and optionally from the infrared heaters 64-70. When the tufted primary backing material 42 bearing the layer 60 of substantially dry thermoplastic particles passes under the infrared heaters 64-70, they are preferably heated to a flowable or liquid state. This allows the molten thermoplastic material to flow into the interstices of both the primary backing material 42 and the loop backs 46 of the tufted filaments, strips, strands, ribbons or filament bundles that form the face pile 44. As the tufted primary backing material 42 bearing the melted thermoplastic polymer particles moves from the thermoplastic polymer particle melting station 62 and passes under the chilled press roller 76, molten thermoplastic polymer particles are pressed into intimate contact with the tufted primary backing material 42 and loop backs 46. The pressure of the chilled press roller 76 on the primary backing material 42 and the loop backs 46 causes the melted thermoplastic polymer particles to flow into both the primary backing material and the loop backs. Then, the chilled press roller 76 cools the primary backing material 42 and loop backs 46 which in turn removes heat from the melted thermoplastic polymer particles and causes them to solidify thereby securely anchoring the loop backs in the primary backing material. The polymer coated synthetic turf structure 78 moves with the belt 12 from the chilled press roller 76 to a stripping roller 80 where the coated synthetic turf structure is removed from the belt and collected in a take up roll 82.

Most synthetic turf is made from polyethylene face fiber, which is relatively heat sensitive. When processing synthetic turf that is sensitive to prolonged temperatures above 212° F. (100° C.), the thermoplastic for the polymer particles should be selected so that it melts at a temperature near 212° F. (100° C.), such as at approximately 225° F. This prevents the synthetic turf fibers from being adversely affected while the thermoplastic polymer particles are being melted and mechanically driven into the primary backing material by the chilled press roller 76. Additionally, the heated air oven 58 can be partitioned so that the lower portion of the oven, in which the face fiber of the synthetic turf is disposed, can be at a lower temperature than the upper portion of the oven, in which the primary backing material 42 bearing the layer 56 of foam of aqueous dispersion of thermoplastic polymer particles is disposed.

In another disclosed embodiment of the present invention, the aqueous polymer dispersion comprises water and solid colloidal polymer particles. The aqueous dispersion is colloidally stable, meaning that it can sit on a shelf for years and the colloidal polymer particles will remain dispersed, without sedimentation of particles making “sludge” at the bottom. The colloidal polymeric particles usually have a diameter of a few hundred nanometers or less. Depending on the particular application, there can also be a complex mixture of pigments, surfactants, plasticizing aids and/or rheological modifiers. The aqueous polymer dispersion can be any aqueous polymer dispersion that can be used for tuft lock or tuft bind in tufted carpets or tufted synthetic turf. Such aqueous polymer dispersions are well known and are commercially available. The colloidal polymer particles are preferably either thermosetting polymers or first thermoplastic polymers. Additionally, in the water portion of the aqueous polymer dispersion are uniformly dispersed larger second thermoplastic polymer particles. The second thermoplastic polymer particles have a particles size that is sufficiently small such that they can be uniformly dispersed in the water portion of the aqueous polymer dispersion, but sufficiently large such that the thermoplastic polymer particles do not substantially penetrate the interstices of the primary backing material, but, instead form a layer on the surface of the primary backing material to which the aqueous polymer dispersion is applied. Preferably, the second thermoplastic polymer particles have an average particle size of approximately 200 micron to approximately 1,000 microns, preferably approximately 400 micron to approximately 800 microns. The second thermoplastic polymer particles can be ground from polymer pellets to the desired particle sizes using methods known in the art including, but not limited to, a pulverizer or a hammer mill.

The colloidal polymer particles; i.e., either thermosetting or thermoplastic, comprise about 5% to about 95% by weight and the larger second thermoplastic polymer particles comprise about 5% to about 95% by weight based on the total weight of dry polymer; i.e., the combined weight of dry colloidal polymer particles and dry second thermoplastic polymer particles. Preferably, the colloidal polymer particles comprise about 50% to about 95% by weight based on the total weight of dry polymer, more preferably about 50% to about 60% by weight based on the total weight of dry polymer. Preferably, the second thermoplastic polymer particles comprise about 5% to about 50% by weight based on the total weight of dry polymer, more preferably about 40% to about 50% by weight based on the total weight of dry polymer. The percentages listed above include all of the intermediate percentage values.

The aqueous polymer dispersion comprises water and both colloidal polymer particles and larger second thermoplastic particles (as discussed above) dispersed therein. The aqueous polymer dispersion contains approximately 5% to approximately 90% by weight polymer solids, preferably approximately 30% to approximately 70% by weight polymer solids, more preferably approximately 50% by weight polymer solids.

In order to assist in the suspension and dispersion of both the colloidal polymer particles and the larger second thermoplastic polymer particles, approximately 0.1% to approximately 10% by weight of a dispersion agent can be included. If a commercially available aqueous polymer dispersion is used, for example a polymer latex, it will already include a dispersion agent and usually no additional dispersion agent is necessary for the second thermoplastic polymer particles. Suitable dispersion agents are those typically used to make aqueous polymer dispersions from solid, non-soluble polymer particles of the sizes set forth above and include, but are not limited to, guar gum, agar gum, xanthan gum, and sodium polyacrylate.

If the aqueous polymer dispersion is to be made into a foam, the aqueous polymer dispersion composition can additionally include a foaming agent, preferably approximately 0.5% to approximately 5% by weight foaming agent, more preferably approximately 1% to approximately 2% by weight foaming agent, most preferably approximately 1% by weight foaming agent. Suitable foaming agents are those typically used in the carpet industry and include, but are not limited to, sodium lauryl sulfate and sodium lauryl ether sulfate.

The aqueous polymer dispersion can optionally include one or more of the following additional ingredients: a plasticizer, a thickener, a lubricant, a wetting agent, a blowing agent, a colorant, a fire retardant and an inert filler. These additives generally are preferably added to the aqueous polymer dispersion at the rates shown in Table 1 above.

The colloidal thermosetting polymer particles can be made from any thermosetting polymer that can be used in carpet or synthetic turf applications as a precoat. Preferred the colloidal thermosetting polymer particles are styrene butadiene (SBR), carboxylated styrene butadiene or vinyl acetate ethylene (VAE).

The second thermoplastic polymer particles can be made from any thermoplastic polymer that can be used in carpet or synthetic turf. Preferably the second thermoplastic polymer particles include, but are not limited to, nylons, polyethylene, polypropylene, polystyrene, poly(methyl methacrylate), poly(vinyl chloride), poly(vinyl acetate), polycarbonate, polycaprolactone, poly(ethylene oxide), poly(vinyl alcohol), poly(ethylene terephthalate), poly(ether sulphone), poly(butyl terephthalate), poly(ethyl methacrylate), ultrahigh molecular weight polyethylene. Particularly preferred second thermoplastic polymers include nylon, including polyadipamide, polycaprolactam, copolymers, and blends thereof; polyolefins, including polyethylene, polypropylene, copolymers and blends thereof; thermoplastic polyester, including polytrimethyleneterephthlate and polyethyleneterephthalate, and blends thereof; acrylics, including polyacrylonitrile; co-polymers and blends thereof. Especially preferred second thermoplastic polymers particles are high density polyethylene (HDPE), low density polyethylene (LDPE), linear low density polyethylene (LLDPE), polypropylene (PP), poly-vinyl chloride (PVC), ethylene-vinyl acetate (EVA), styrene ethylene butylene styrene (SEBS), poly(styrene-block-butadiene-block-styrene) (SBS), polyamide, acrylonitrile butadiene styrene (ABS), thermoplastic polyurethane (TPU), polylactic acid (PLA), ethyl methacrylate (EMA) or polyester. The second thermoplastic polymer particles can be amorphous, semi-crystalline or crystalline before they are heated. The process is applicable to single polymers and to mixtures of polymers. For example, the mixture may be of polymers of the same composition but of different molecular weight, or chemically different polymers.

The colloidal thermoplastic polymer particles can be made from the same polymers as the second thermoplastic polymer particles as long as they can be ground to the necessary particle size. For example, low density polyethylene (LDPE) is not desirable for the colloidal thermoplastic polymer particles because it is too soft to grind to the colloidal particle size in a cost effective manner. However, high density polyethylene (HDPE) is useful for the colloidal thermoplastic polymer particles. Other preferred colloidal thermoplastic polymers include, but are not limited to, ethylene acrylic acid, polypropylene, polyethylene and copolymers thereof.

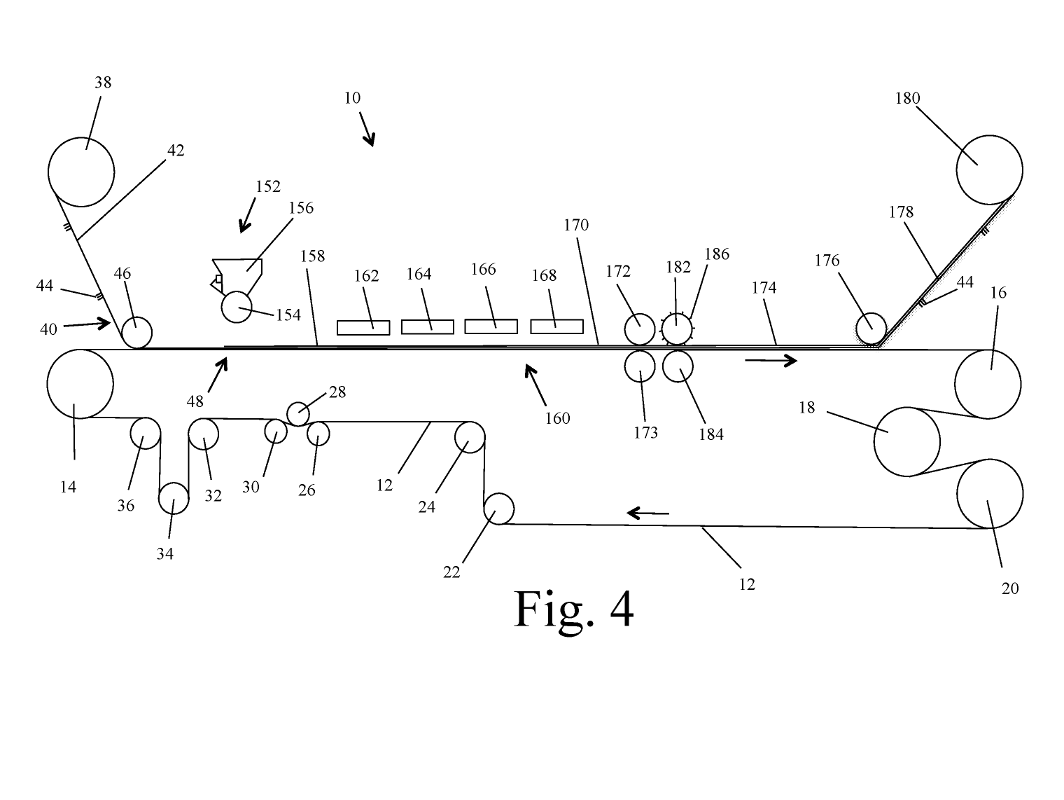

Another disclosed embodiment of the present invention is shown in FIG. 4. The apparatus shown in FIG. 4 is identical to the apparatus shown in FIG. 1 with respect to the belt, belt path and belt drive apparatus. With reference to FIG. 4, the tufted greige goods 40 on the belt 12 moves from the roller 46 to a polymer deposition station 48. The polymer deposition station 48 comprises a solid particle scatter coater 152 disposed above the tufted greige goods 40 on the belt 12. The particle scatter coater 152 comprises a knurled roller 154 that extends across the width of the primary backing material 42. The knurled roller 154 is rotatably driven by a variable speed motor (not shown). The knurled roller 154 is positioned below a hopper 156 that interfaces with the knurled roller so that solid particles disposed in the hopper are picked up by the knurls of the knurled roller as it rotates. As the knurled roller 154 rotates, the solid particles fall from the knurled roller onto the surface of the primary backing material 42 and form a randomly dispersed coating of solid particles thereon. Scatter coaters are known in the art and are commercially available from Practix Manufacturing LLC, Acworth, Ga. and Sandvik TPS Division of Sandvik Materials Technology Deutschland GmbH, Goppingen, Germany. While the present embodiment of the scatter coater has been illustrated as using a knurled roller, the present invention can also be practiced with a carded cloth covered roller instead of the knurled roller.

The solid polymer particles that are used to scatter coat the primary backing material 42 preferably comprise solid polymer particles, more preferably solid polyethylene polymer particles. The polyethylene is in solid particulate form having an average particle size (volume-based) of approximately 1 to approximately 1,000 microns. Stated another way, the size of the solid polyethylene polymer particles is such that they will pass through an 18-mesh screen. The solid polyethylene polymer particles can be ground from polyethylene polymer pellets to the desired particle sizes using methods known in the art including, but not limited to, a pulverizer or a hammer mill. Additionally, the polyethylene from which the solid particles are made preferably has a melt index of approximately 50 to approximately 500 g/10 minutes at 190° C. and at a weight of 2.16 kg., more preferably approximately 150 to approximately 250 g/10 minutes at 190° C., especially approximately 200 g/10 minutes at 190° C. and at a weight of 2.16 kg. Melt Index as used herein is the measurement procedure set forth in ASTM D1238-13. Furthermore, the polyethylene from which the solid particles are made preferably has a melting point of approximately 150 to approximately 250° F., more preferably approximately 200 to approximately 235° F., especially approximately 215° F.

The solid polyethylene polymer particles dispensed from the scatter coater 152 form a random coating of solid particles 158 on the primary backing material 42 preferably at a rate of approximately 5 ounces per square yard to approximately 18 ounces per square yard of polymer are applied to the primary backing material 42 and loop backs 46, more preferably approximately 8 ounces per square yard to approximately 18 ounces per square yard, most preferably approximately 8 ounces per square yard to approximately 13 ounces per square yard, especially preferably approximately 5 ounces per square yard to approximately 13 ounces per square yard, more especially approximately 5 ounces per square yard to approximately 8 ounces per square yard. The foregoing ranges of polyethylene polymer applied to the primary backing material 42 include all of the intermediate values.

Optionally, the polyethylene polymer from which the solid particles are formed can optionally include additives including, but not limited to, pigments, plasticizing aids, a lubricant, a blowing agent, a fire retardant, an inert filler and/or rheological modifiers.

The tufted primary backing material 42 bearing the coating or layer 158 of solid polyethylene polymer particles on the belt 12 moves from the polymer deposition station 48 to a polymer particle melting station 160. The polymer particle melting station 160 comprises a plurality of infrared heaters 162, 164, 166, 168 disposed above the tufted primary backing material 42 bearing the layer 158 of solid polyethylene polymer particles on the primary backing material. The infrared heaters 162-168 are positioned a distance above the belt 12, the belt is at a speed and the infrared heaters are of a size such that the residence time of the tufted primary backing material 42 bearing the layer 158 of solid polyethylene polymer particles under the infrared heaters is such that the solid polyethylene polymer particles on the primary backing material are heated to a temperature sufficient to melt the solid polyethylene polymer particles so that they are fluid. The objective of using the infrared heaters 162-168 is to convert the solid polyethylene polymer particles to a flowable material or a liquid layer 170 on the primary backing material 42.

As the tufted primary backing material 42 bearing the melted polyethylene polymer particles moves from the polymer particle melting station 160 and passes between a chilled press roller assembly comprising a first chilled press roller 172 disposed above the belt 12 and a second opposed chilled press roller 173 disposed below the belt. The chilled press roller 172, 173 are hollow rollers into which coolant is circulated. As the primary backing material 42 and the molten layer 170 of polyethylene polymer pass under the chilled press roller 172, the molten layer of polyethylene polymer is formed into a discontinuous film 74 and pressed into intimate contact with the primary backing material. The pressure of the chilled press roller 72 on the molten layer 70 of polyethylene polymer causes the melted polymer particles to flow into both the primary backing material 42 and the loop backs 46 or tuft bundles in the primary backing material. Then, the chilled press roller 172 cools the molten layer 170 of polyethylene polymer and causes it to solidify into a discontinuous film 174 thereby securely anchoring the loop backs 46 and/or tuft bundles in the primary backing material 42.

The polymer coated turf structure moves with the belt 12 from the chilled press roller 172 to a stripping roller 176 where the polymer coated turf structure 178 is removed from the belt and collected in a take up roll 180.

Unexpectedly, the discontinuous polyethylene film 174 on the primary backing material 42 is water permeable. Water permeability of synthetic turf is determined according to ASTM F1551-09 or FIFA/EN 12616 and DIN 18-035. These testing procedures require a water permeability of the synthetic turf (after installation) of greater than 10 inches of water per hour. The synthetic turf including the polyethylene film 174 in accordance with the present invention meets the foregoing requirement for water permeability, while still providing acceptable tuft bind or bundle lock (without infill) of 6.8 lbs (or 30N) and filament bind or filament slippage in accordance with ASTM D1335 or ISO 4919. The synthetic turf in accordance with the present invention meets the guidelines of the Synthetic Turf Council as set forth in the “Guidelines for Synthetic Turf Performance (2013).”

Optionally, the apparatus 10 can include a spiked press roller 182 that includes a multitude of spikes 186 extending radially outwardly from the surface of the press roller around the periphery thereof. An opposed slotted press roller 184 is disposed below the belt 12. Therefore, as the polymer-coated turf structure 178 moves with the belt 12 from the chilled press rollers 172, 173 it passes between the spiked press roller 182 and the slotted press roller 184. As the polymer-coated turf structure 178 passes under the spiked press roller 182, the spikes 186 form a matrix of holes in the film 174 on the primary backing material 42. The spiked press roller 182 rotates with the movement of the polymer-coated turf 178 with the belt 12 under the spiked press roller 182 thereby forming a matrix of perforation in the polyethylene film 174 across the width and length of the turf structure. The perforated film 174 provides additional water permeability to the synthetic turf. The spiked press roller 182 and the slotted press roller 184 can optionally be chilled. For this option, the chilled spiked press roller 182 and the slotted press roller 184 are hollow rollers into which coolant is circulated.

Optionally, the apparatus 10 can be operated without the chilled press rollers 172, 173, but including the spiked press roller 182 and the slotted press roller 184 that are chilled. In this configuration, the chilled spiked press roller 184 presses the molten layer 174 of polyethylene into intimate contact with the primary backing material 42. The pressure of the spiked chilled press roller 184 on the molten layer 174 of polyethylene polymer causes the melted polymer particles to flow into both the primary backing material 42 and the loop backs 46 or tuft bundles in the primary backing material. Then, the chilled spiked press roller 182 and the chilled slotted press roller 184 cools the molten layer 174 of polyethylene polymer and causes it to solidify into a discontinuous film 74 thereby securely anchoring the loop backs 46 and/or tuft bundles in the primary backing material 42. Simultaneously, the chilled spiked press roller 182 also forms a plurality of holes in the film 174 on the primary backing material 42.

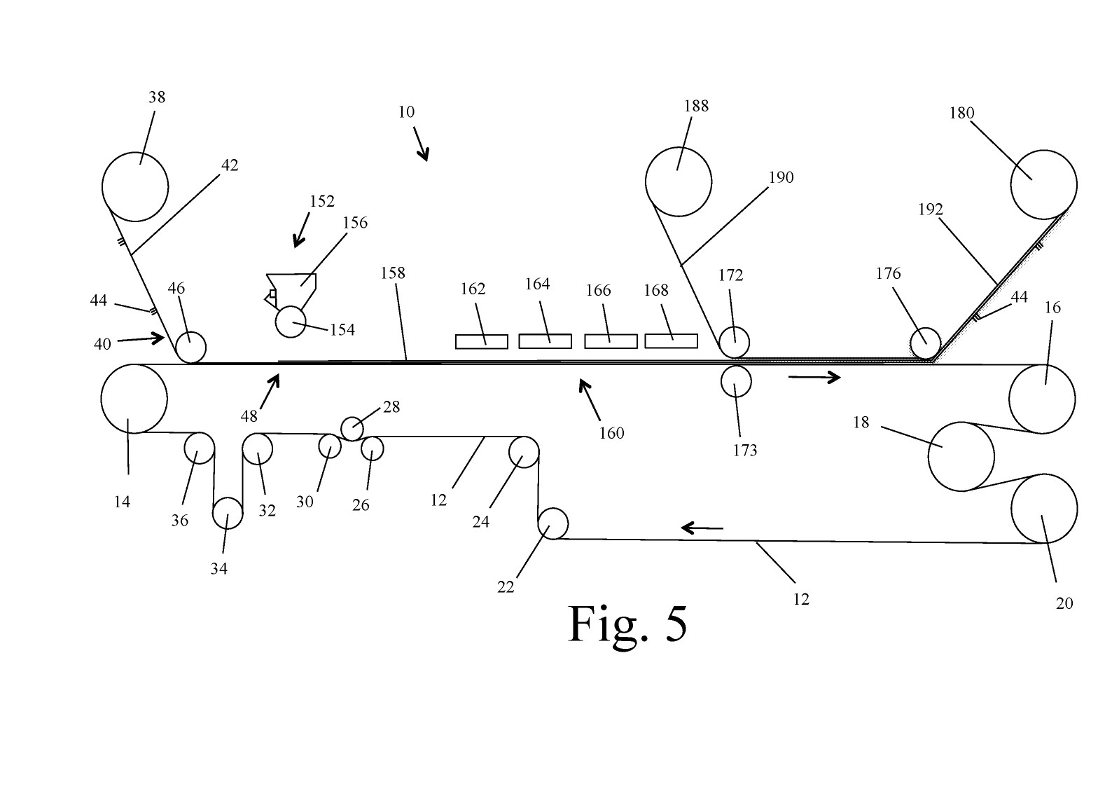

FIG. 5 shows an alternate disclosed embodiment of the present invention. The apparatus shown in FIG. 5 is identical to the apparatus shown in FIG. 4, except there is a secondary backing involved. The processing of the synthetic turf in FIG. 5 is also identical to that shown in FIG. 4 up to the point where the molten polyethylene coated 158 primary backing 42 emerges from the bank of infrared heaters 162-168.

Disposed above the belt 12 is a supply roll 188 of a secondary backing material 190. The secondary backing material 190 feeds from the supply roll 188 under the chilled press roller 172. As the tufted primary backing material 42 bearing the molten layer 174 of polyethylene polymer moves from the polymer particle melting station 160 and passes under the chilled press roller 172, the secondary backing material 190 is pressed into intimate contact with the melted polyethylene polymer on the tufted primary backing material 42. The pressure of the chilled press roller 172 on the primary backing material 42 and the secondary backing material 190 causes the melted polyethylene polymer to flow into both the primary backing material and the secondary backing material. Then, the chilled press roller 172 cools the secondary backing material 190, which in turn removes heat from the melted polyethylene polymer and causes it to solidify thereby securely attaching the secondary backing material to the primary backing material 42 and also further securely anchoring the loop backs 46 in the primary backing material, which forms a laminated synthetic turf structure 192. Optionally, a chilled spiked roller and cooperating slotted roller can be used to perforate both the primary backing material and the secondary backing material.

The secondary backing material 190 is identical to the secondary backing material 74 discussed above. It is particularly preferred that the face pile 44, the primary backing material 42 and the secondary backing material 190 all be made from the same or similar (i.e.; compatible) thermoplastic polymers.

The laminated synthetic turf structure 192 moves with the belt 12 from the chilled press rollers 172, 173 to the stripping roller 176 where the laminated turf structure is removed from the belt and collected in the take up roll 180.

A particular advantage of the present invention is that the polymers used for the thermoplastic polymer particles in the aqueous dispersion can be regrind polymers, off-specification polymers and recycled polymers. Regarding the use of recycled polymers, it is specifically contemplated that the thermoplastic polymer particles in the aqueous dispersion can be obtained from recycled synthetic turf. In that regard, it is contemplated that the process disclosed in U.S. Pat. No. 8,809,405 (the disclosure of which is incorporated herein by reference in its entirety) can be used to provide thermoplastic polymer pellets for use in the present invention. In addition, a synthetic turf made in accordance with the present invention employing a thermoplastic face pile, primary backing and secondary backing will be completely recyclable and can be used as feedstock for the process disclosed in U.S. Pat. No. 8,809,405.

Another advantage of the present invention is that the use of a foam of an aqueous dispersion of thermoplastic polymer particles provides a convenient way to uniformly and repeatable deposit relatively small amounts of thermoplastic polymer particles on a primary backing of a synthetic turf. These relatively small amounts of adhesive provide cost saving in manufacturing costs while not significantly adversely affecting physical properties, especially tuft lock and bond strength between the primary backing and secondary backing.

The following examples are illustrative of selected embodiments of the present invention and are not intended to limit the scope of the invention.

### Example 1

A synthetic turf product is prepared in accordance with the present invention. The turf comprises a 2.5 inch pile height polyethylene face fiber tufted into a woven polypropylene primary backing. An aqueous dispersion of thermoplastic polymer particles is prepared having the following formulation as shown in Table 2:

TABLE 2

| Ingredient | Percent by Weight |
|---|---|
| Water | 69.3 |
| Dispersion agent (xanthan gum) | 0.2 |
| Polyethylene particles (having an average | 30.0 |
| particle size of 80 microns) | |
| Sodium lauryl sulfate | 0.5 |

The synthetic turf is processed in accordance with the present invention as described above and shown in FIG. 1. The aqueous dispersion of Table 2 is converted to a foam in a frothing machine. The foamed aqueous dispersion of thermoplastic polymer particles is applied to the primary backing and formed into a uniform layer at the rate of 16 ounces of polymer per square yard and the resulting layer is approximately 0.25 inches thick. The foam coated polypropylene primary backing is heated in a heated oven at a temperature of 212° F. for a period of 4 minutes until the aqueous dispersion is substantially dry. In the heated oven the foam quickly collapses and the substantially dry coating has no remaining foam structure. The thermoplastic polymer particle coated primary backing is then heated at a temperature of 225° F. for a period of 4 minutes until the thermoplastic polymer particles melt. A woven secondary backing made from polypropylene is then applied to the melted thermoplastic polymer particles. The primary backing and secondary backing are run under a chilled press roller so that the primary backing and secondary backing are pressed into intimate contact and the melted thermoplastic polymer particles flow both between the fibers of the woven primary and secondary backings and also into the interstices of the ribbons that make up the primary and secondary backings and into the loop backs of the tufted filament bundles. The chilled press roller removes heat from the molten thermoplastic polymer particles and causes them to solidify. The result is that the secondary backing is securely attached to the primary backing and the synthetic turf tufts are securely locked into the primary backing.

### Example 2

A synthetic turf product is prepared in accordance with the present invention. The synthetic turf comprises a 2.5 inch pile height polyethylene face fiber tufted into a woven polypropylene primary backing. An aqueous dispersion of thermoplastic polymer particles is prepared having the formulation as shown in Table 2 above.

The synthetic turf is processed in accordance with the present invention as described above. The aqueous dispersion of Table 2 is converted to a foam in a frothing machine. The foamed aqueous dispersion of thermoplastic polymer particles is applied to the synthetic turf polypropylene primary backing and formed into a uniform layer at the rate of 16 ounces per square yard and the resulting layer is approximately 0.25 inches thick. The foam coated polypropylene primary backing is heated in a heated oven at a temperature of 212° F. for a period of 4 minutes until the aqueous dispersion is substantially dry. In the heated oven the foam quickly collapses and the substantially dry coating has no remaining foam structure. The thermoplastic polymer particle coated synthetic turf primary backing is then heated at a temperature of 225° F. for a period of 4 minutes until the thermoplastic polymer particles melt. The synthetic turf primary backing is then run under a chilled press roller so that the melted thermoplastic polymer particles flow between the fibers of the woven primary backing, into the interstices of the yarns that make up the primary backing and at least partially cover the loop backs of the face pile. The chilled press roller removes heat from the molten thermoplastic polymer particles and causes them to solidify. The result is that the loop backs of the face pile are securely attached to the primary backing of the synthetic turf.

### Example 3

A 2.5 inch pile height polyethylene face fiber synthetic turf with a polypropylene woven primary and a thermoset polyurethane precoat is selected for testing. The synthetic turf is comprised of 51% by weight polyethylene, 14% by weight polypropylene and 35% by weight thermoset polyurethane. The synthetic turf is removed from a sports facility using a Turf Muncher to strip the turf from the field, 95% by weight of the infill material is remove and the turf is rolled into a roll. The turf roll is cut into strips 36 inches wide. The strips are fed into a Series 14 Grinder from Jordon Reduction Solutions of Birmingham, Ala. where the turf strips are ground/cut into particles having a maximum dimension of ⅜ inch. The size reduced synthetic turf is processed through a 4 inch single screw extruder with a 26:1 L/D at 400° F., which is a sufficient temperature to melt the thermoplastic material from which the synthetic turf is made. The extruder is equipped with a 300 horsepower electric motor. The extruder is a Model 6 PM III from NRM Corporation from Columbiana, Ohio. Optionally, 8.6% by weight Westlake GA7502 from Westlake Chemical, which is a maleic anhydride modified methyl acrylate copolymer is added to the molten material during the extrusion process. The extruded molten polymer is pelletized under water using a Gala 6 underwater pelletizer manufactured by Gala Industries, Inc., Eagle Rock, Va.

The thermoplastic polymer pellets are ground to an average particle size of 80 microns by feeding the thermoplastic polymer pellets into a pulverizer. The resulting thermoplastic polymer particles are incorporated into the aqueous dispersion of Table 2 and processed in the same manner as described above in Example 1. The resulting synthetic turf has excellent physical properties, the secondary backing is securely attached to the primary backing and the loop backs of the face pile yarns are securely locked in the primary backing.

### Example 4

Aqueous dispersions of thermoplastic polymer particles are prepared according to the formulations listed in Tables 3-8 below as follows:

TABLE 3

| Ingredient | Percent by Weight |
|---|---|
| Water | 65.5 |
| 8201 Paste Base (dispersion agent) | 4 |
| 1502 Polypropylene granules (having a | 30.0 |
| particle size of 500-1,000 microns) | |
| PS 8300 Thickener | 0.5 |

TABLE 4

| Ingredient | Percent by Weight |
|---|---|
| Water | 65.5 |
| 8201 Paste Base (dispersion agent) | 4 |
| 1502 Polypropylene granules (having a | 30.0 |
| particle size of 500-1,000 microns) | |
| PS 8300 Thickener | 1 |
| Manwet sodium lauryl sulfate | 2 |

TABLE 5

| Ingredient | Percent by Weight |
|---|---|
| Water | 63.25 |
| 8201 Paste Base (dispersion agent) | 4 |
| Ace 2000P low density polyethylene | 30.0 |
| powder (having an average particle size of | |
| 0-841 microns) | |
| PS 8300 Thickener | 0.75 |
| Manwet sodium lauryl sulfate | 2 |

TABLE 6

| Ingredient | Percent by Weight |
|---|---|
| Water | 67.25 |
| N100-20 Polypropylene granules (having | 30.0 |
| an average particle size of 80 microns) | |
| PS 8300 Thickener | 0.75 |
| Manwet sodium lauryl sulfate | 2 |

TABLE 7

| Ingredient | Percent by Weight |
|---|---|
| Water | 69.3 |
| N100-20 Polypropylene granules (having | 30.0 |
| an average particle size of 80 microns) | |
| Xanthan gum | 0.2 |
| Sodium lauryl sulfate | 0.5 |

TABLE 8

| Ingredient | Percent by Weight |
|---|---|
| Water | 69.3 |
| N100-20 Polypropylene granules (having | 20.0 |
| an average particle size of 80 microns) | |
| Xanthan gum | 0.2 |
| Calcium carbonate | 10 |

The aqueous dispersions of thermoplastic polymer particles prepared according to the formulations of Tables 3-8 above are used to prepare carpets in accordance with Example 1, except the formulations of Tables 3 and 8 are applied to the primary backing as a liquid instead of as a foam. All of the foregoing formulations produce synthetic turf having excellent adhesion of the secondary backing to the primary backing and excellent tuft lock.

### Example 5

A tufted synthetic turf product is prepared in accordance with the present invention. The carpet comprises a 2.5 inch pile height polyethylene face fiber tufted into a woven polypropylene primary backing. An aqueous polymer dispersion composition is prepared having the following formulation as shown in Table 9:

TABLE 9

| Ingredient | Percent by Weight | Description |
|---|---|---|
| X-7358 | 75 | VAE Latex |
| Ace 2000P | 25 | 200 MI LDPE 0-840 micron |

The particles size for the Ace 2000P low density polyethylene thermoplastic particles is shown in Table 10 below:

TABLE 10
Ace 2000P Particle Size Distribution

| | |
|---|---|
| 500-841 micron | 44.30% |
| 212-500 micron | 51.17% |
| 90-212 micron | 4.43% |
| 0-90 micron | <0.1% |
| Approximate Average: | 589.45 microns |

Table 10 shows that the Ace 2000P thermoplastic particles have a calculated approximate average particle size of 589 microns with less than 5% of the particles falling below 200 microns.

The synthetic turf is processed in accordance with the present invention as described above and shown in FIG. 1. The aqueous polymer dispersion of Table 9 is converted to a foam in a frothing machine. The foamed aqueous polymer dispersion is applied to the primary backing and formed into a uniform layer at the rate of 16 ounces per square yard and the resulting layer is approximately 0.25 inches thick. The aqueous polymer dispersion foam coated polypropylene primary backing is heated in a heated oven at a temperature of 275° F. for a period of 8 minutes until the aqueous polymer dispersion is substantially dry. In the heated oven, the aqueous polymer dispersion foam quickly collapses and the substantially dry coating has no remaining foam structure. The colloidal thermosetting (SBR) particles of the aqueous polymer dispersion permeate into the interstices of the primary backing and the loop backs of the tufts and are fused in place. The second thermoplastic polymer (LDPE) particle coated primary backing is then heated to a temperature of 250° F. under the infrared heaters for a period of 30 seconds until the second thermoplastic polymer particles melt. A woven secondary backing made from polypropylene is then applied to the melted second thermoplastic polymer particles. The primary backing and secondary backing pass under a chilled press roller so that the primary backing and secondary backing are pressed into intimate contact and the melted second thermoplastic polymer particles flow between the fibers of both the woven primary and secondary backings. The chilled press roller removes heat from the molten thermoplastic polymer particles and causes them to solidify. The result is that the secondary backing is securely attached to the primary backing and the synthetic turf tufts are securely locked into the primary backing.

### Example 6

A tufted carpet product is prepared in the same manner as Example 5 above, except that an aqueous polymer dispersion composition is prepared having the following formulation as shown in Table 11:

TABLE 11

| Ingredient | Percent by Weight | Description |
|---|---|---|
| X-7358 | 75 | VAE Latex |
| Rowalit H200 | 25 | 200 MI LDPE 0-200 micron |

The particles size for the Rowalit H200 low density polyethylene thermoplastic particles is shown in Table 12 below:

TABLE 12
H200 Particle Size Distribution

| | |
|---|---|
| 80-212 micron | 97.10% |
| 0-80 micron | 2.90% |
| Approximate Average: | 142.926 microns |

Table 12 shows that the H200 thermoplastic particles have a calculated approximate average particle size of 143 microns.

### Example 7

The tufted synthetic turf products prepared in Examples 5 and 6 above were subjected to delamination testing. The synthetic turf samples were tested in accordance with ASTM D3936-035. The results of the delamination testing are shown in Table 13 below.

TABLE 13

| | | Weight | | Particle Size |
|---|---|---|---|---|
| Sample | Delamination (lb/in) | (oz./yd²) | Polymer | Range (microns) |
| 1A | 3.13 | 10.62 | 2000P | 0-840 |
| 1B | 1.67 | 9.9 | 2000P | 0-840 |
| 1C | 1.26 | 5.72 | 2000P | 0-840 |
| 1D | 0.91 | 5.22 | 2000P | 0-840 |
| 2A | 0.59 | 9.73 | H-200 | 0-200 |
| 2B | 2.01 | 11.77 | H-200 | 0-200 |
| 2C | 0.68 | 6.61 | H-200 | 0-200 |
| 2D | 0.71 | 6.61 | H-200 | 0-200 |

The results shown in Table 13 above show that using a 200 Melt Index LDPE polymer with a 143 micron average particle size will give a delamination strength that is 35% to 45% lower than the same polymer with a 589 micron average particle size.

### Example 8

A tufted synthetic turf is prepared in accordance with the present invention using the apparatus disclosed in FIG. 4. The primary backing is tufted with 5 strands per tuft bundles. The greige goods comprise a 2-inch pile height of polyethylene strands tufted into a woven polypropylene primary backing. Polyethylene polymer pellets are ground to form fine particles having a volume-based average particle size of approximately 590 microns. The polyethylene has a melting point of 225° F. and a melt index of 200 g/10 min. at 190° C. and a weight of 2.16 kg. as measured in accordance with ASTM D1238-13.

The polyethylene particles are applied to the primary backing of the greige goods 42 from the scatter coater 152 to form a layer thereon at the rate of 15 ounces per square yard. The particle-coated primary backing 158 is passed under the bank of infrared heaters 162-168 to heat the polymer particles. The polyethylene polymer particles are heated to a temperature above their melting point so that they are rendered flowable. The primary backing bearing the coating of melted polyethylene is passed under the chilled press roller 172 so that the molten polyethylene is turned into a discontinuous polymer film on the primary backing.

The synthetic turf is tested for bundle lock and filament slippage (filament bind). Bundle lock results are shown in Table 14 below and the filament slippage results are shown in Table 15 below. The tested water permeability rate of the coated turf (with no infill and prior to installation on a field) is 124 inches per hour, which is more than sufficient to pass the STC requirements.

TABLE 14
Tuft bind results of coated synthetic turf.

| Sample # | Bundle Lock (lbf) |
|---|---|
| Sample 1655 | 11.795 |
| Sample 1656 | 13.942 |
| Sample 1657 | 13.087 |
| Sample 1658 | 13.686 |
| Sample 1659 | 14.527 |
| Sample 1660 | 12.899 |
| Sample 1661 | 13.013 |
| Sample 1662 | 13.067 |
| Sample 1663 | 13.511 |
| Sample 1664 | 13.209 |
| Sample 1665 | 13.592 |
| Sample 1666 | 12.186 |
| Sample 1667 | 13.276 |
| Sample 1668 | 13.377 |
| Sample 1669 | 11.607 |
| Average | 13.118 |
| Min | 11.607 |
| Max | 14.527 |

TABLE 15
Filament slippage test results for coated synthetic turf.

| Sample # | Filament Slip (lbf) |
|---|---|
| Sample 1670 | 2.739 |
| Sample 1671 | 3.203 |
| Sample 1672 | 2.981 |
| Sample 1673 | 3.324 |
| Sample 1674 | 2.692 |
| Sample 1675 | 3.169 |
| Sample 1676 | 3.115 |
| Sample 1677 | 3.048 |
| Sample 1678 | 3.378 |
| Sample 1679 | 3.163 |
| Sample 1680 | 3.25 |
| Sample 1681 | 3.237 |
| Sample 1682 | 3.062 |
| Sample 1683 | 3.122 |
| Sample 1684 | 3.223 |
| Average | 3.114 |
| Min | 2.692 |
| Max | 3.378 |

### Example 9

A tufted synthetic turf is prepared in accordance with the present invention using the apparatus disclosed in FIG. 5. The primary backing is tufted with 5 strands per tuft bundles. The greige goods comprise a 2-inch pile height of polyethylene strands tufted into a woven polypropylene primary backing. Polyethylene polymer pellets are ground to form fine particles having a volume-based average particle size of approximately 590 microns. The polyethylene has a melting point of 225° F. and a melt index of 200 g/10 min. at 190° C. and a weight of 2.16 kg., as measured in accordance with ASTM D1238-13.

The polyethylene polymer particles are applied to the primary backing of the greige goods 42 from the scatter coater 152 to form a layer thereon at the rate of 16 ounces per square yard. The particle-coated primary backing 158 is passed under the bank of infrared heaters 162-168 to heat the polymer particles. The polyethylene particles are heated to a temperature above their melting point so that they are rendered flowable. Using the apparatus shown in FIG. 4, the primary backing bearing the coating of melted polyethylene 170 is passed under the chilled press roller 172 while a roll of 4.5 ounce/yd² polyester nonwoven secondary fabric 190 is fed in to the top side of the press roller 72 and pressed into intimate contact with the molten polyethylene. The resulting composite is tested for tuft bind and delamination strength with results shown in Table 16 and Table 4 respectively below.

TABLE 16
Tuft bind of synthetic turf with secondary fabric

| Sample # | Tuft Bind (lbf) |
|---|---|
| Sample 2388 | 12.778 |
| Sample 2389 | 13.437 |
| Sample 2390 | 14.366 |
| Sample 2391 | 13.249 |
| Sample 2392 | 14.016 |
| Average | 13.569 |
| Min | 12.778 |
| Max | 14.366 |

TABLE 17
Delamination strength of synthetic turf with secondary fabric

| Sample # | Delamination (lbf) |
|---|---|
| Sample 2387 Peak 1 | 7.227 |
| Sample 2387 Peak 2 | 6.016 |
| Sample 2387 Peak 3 | 5.587 |
| Sample 2387 Peak 4 | 5.926 |
| Sample 2387 Peak 5 | 6.471 |
| Average | 6.245 |
| Min | 5.587 |
| Max | 7.227 |

These foregoing results show that a single compound can be used to achieve desirable tuft bind as well as delamination strength in a single processing step.

### Example 10

A tufted synthetic turf is prepared in accordance with the present invention using the apparatus disclosed in FIG. 4. The primary backing is tufted with 5 strands per tuft bundles. The greige goods comprise a 2-inch pile height of polyethylene strands tufted into a woven polypropylene primary backing. Polyethylene polymer pellets are ground to form fine particles having a volume-based average particle size of approximately 590 microns. The polyethylene has a melting point of 225° F. and a melt index of 200 g/10 min. at 190° C. and a weight of 2.16 kg., as measured in accordance with ASTM D1238-13.

The polyethylene particles are applied to the primary backing of the greige goods 42 from the scatter coater 152 to form a layer thereon at the rate of 17 ounces per square yard. The particle-coated primary backing 158 is passed under the bank of infrared heaters 162-168 to heat the polymer particles. The polyethylene particles are heated to a temperature above their melting point so that they are rendered flowable. Using the apparatus shown in FIG. 5, the primary backing bearing the coating of melted polyethylene 170 is pressed between the spiked press roll 182 and the slotted roller 184 in order to mold holes into the polyethylene film (the chilled press rollers 172, 173 are omitted in this embodiment). The spikes 186 of the chilled spiked press roller 182 create ⅛ inch diameter holes spaced at ½ inch intervals from each other in both the length and width direction. The drainage rate of this synthetic turf with the perforated polyethylene film without infill or installation is 3600 inches per hour. When the spiked press roller 182 creates ⅛ inch diameter holes spaced at 1-inch intervals in the length and width direction, the drainage rate is 1800 inches per hour. And, when the spiked press roller 182 creates ⅛ inch diameter holes spaced at 1.5 inch intervals in the length and width direction, the drainage rate is 1030 inches per hour. Each of these values is sufficient to pass the ASTM F1551-09 or FIFA/EN 12616 standards for water permeability of synthetic turf.

### Example 11

A tufted synthetic turf is prepared in accordance with the present invention using the apparatus disclosed in FIG. 4. Five different turfs were prepared in accordance with the present invention. Each sample included a 15 oz/yd² polymer coating on the primary backing material. Sample #1 was a tufted primary backing without a secondary backing. Sample #2 was the same as Sample #1, except that the turf included a 4.5 oz/yd² polyester nonwoven fabric secondary backing. Sample #3 was a tufted primary backing without a secondary backing with 3 lbs/yd² of sand infill. Sample #4 was identical to Sample #3. Sample #5 was a tufted primary backing without a secondary backing with 2 lbs/yd² of sand and 2 lbs/yd² of ground rubber infill. Each turf sample was subjected to a water permeability test in accordance with ASTM F1551-09 or FIFA/EN 12616. The results are shown in Table 18 below.

TABLE 18
Turf Water Permeability Test

| | Seconds to Drain | | |
|---|---|---|---|
| Sample No. | 6 inches of water | in/hr | gal/min/yd² |
| #1 - Synthetic turf no | 19 | 326.19 | 106.31 |
| secondary | | | |
| #2 - Synthetic turf with | 105 | 59.02 | 19.24 |
| 4.5 oz/yd² polyester | | | |
| nonwoven fabric | | | |
| secondary backing | | | |
| #3 - Landscape turf w/ | 11 | 563.41 | 183.63 |
| 3 lbs/yd² sand | | | |
| #4 - Landscape turf w/ | 12 | 516.46 | 168.33 |
| 3 lbs/yd² sand | | | |
| #5 - Sports turf w/ 2 lbs/yd² | 12 | 516.46 | 168.33 |
| sand and 2 lbs/yd² | | | |
| ground rubber | | | |

The foregoing test results surprisingly demonstrate a very large water permeability far in excess of the water permeability set forth in ASTM F1551-09 or FIFA/EN 12616.

### Example 12

A tufted synthetic turf is prepared in accordance with the present invention using the apparatus disclosed in FIG. 4. Five different turfs were prepared in accordance with the present invention. Permeability was tested in accordance with ASTM F1551. Sample Nos. 1-3 and 5 were performed on a synthetic turf tufted on a ⅜ gauge machine with 4 stitches per inch using two woven primary backings. Sample No. 4 was a synthetic landscape turf tufted on a 3/16 gauge tufting machine with 3.5 stitches per inch using two woven primaries. The results are shown in Table 19 below.

TABLE 19
Turf Water Permeability Test

| | | Seconds | |
|---|---|---|---|
| | Polymer | to Drain 6 | |
| | Application | inches | Inches |
| Sample No. | Weight (oz/yd²) | of water | water/hr |
| #1 - holes punched with 1 | 16 | 8 | 774.69 |
| inch × 1 inch centers with | | | |
| 0.250 inch diameter holes | | | |
| #2 - no holes punched | 16 | 31 | 199.92 |
| #3 - no holes punched | 0 | 2 | 3,098.80 |
| #4 - no holes punched | 0 | 3 | 2,065.69 |
| #5 - holes punched with 3 | 16 | 9 | 688.61 |
| inch × 4 inch centers with | | | |
| 0.250 inch diameter holes | | | |

The foregoing tests demonstrate that acceptable drainage results can be achieved with polymer application weights of 16 ounces. These test also demonstrate that hole punching has a positive effect of synthetic turf drainage properties.

### Example 13

A tufted synthetic turf is prepared in accordance with the present invention using the apparatus disclosed in FIG. 4. Seven different turfs were prepared in accordance with the present invention. Permeability was tested in accordance with ASTM F1551. Tuft bind tests and filament bind tests were measured in accordance with ASTM D1335 or ISO 4919. As stated above, acceptable tuft bind or bundle lock (without infill) of 6.8 lbs (or 30N) is the minimum recognized by the industry. All tests were performed on a synthetic turf tufted on a ⅜ gauge machine with 4 stitches per inch using two woven primary backings. The results are shown in Table 20 below.

TABLE 20
Turf Water Permeability and Tuft/Filament Bind Test

| | Polymer | | | | |
|---|---|---|---|---|---|
| | Application | Seconds to | | Tuft | Filament |
| Sample | Weight | Drain 6 inches | Inches | Bind | Bind |
| No. | (oz/yd²) | of water | water/hr | (lbs) | (lbs) |
| 101C | 12 | 15 | 463.05 | 13.312 | 2.994 |
| 101B | 10 | 9 | 771.73 | 8.39 | 2.503 |
| 101A | 8 | 7 | 992 | 7.643 | 2.49 |
| 101D | 6 | 7 | 992 | 10.115 | 2.892 |
| 101E | 4 | 6 | 1,157 | 5.807 | 2.318 |
| 101F | 0 | 6 | 1,157 | 5.049 | 2.331 |

The foregoing tests show that very good water permeability and acceptable tuft bind and filament bind properties can be achieved using the present invention with polymer application weights as low as approximately 6 ounces per square yard of synthetic turf, but greater than 0 or 4 ounces per square yard of synthetic turf.

This data also shows that one can design a synthetic turf product that can achieve good physical properties for specific end uses with the lower polymer application weights. An example would be to tuft on a lower gauge machine; e.g., 1/10 gauge, so that utilization of the powder or aqueous polymer application weights would be sufficient to cover the yarn and avoid the direct heat from an IR heating system. Landscape turf would be a good candidate.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A method comprising:
(a) applying to a primary backing and loop backs of a tufted synthetic turf one of:
(i) a quantity of an aqueous dispersion of thermoplastic polymer particles have an average particle size of approximately 1 micron to approximately 1,000 microns;
(ii) an aqueous dispersion of colloidal thermosetting polymer particles or colloidal thermoplastic polymer particles and second thermoplastic polymer particles dispersed in the aqueous dispersion, wherein the second thermoplastic polymer particles have an average particle size of approximately 200 micron to approximately 1,000 microns; or
(iii) a plurality of solid polyethylene polymer particles to a first primary surface of a tufted primary backing to form a coating thereon, wherein the solid polyethylene polymer particles have an average particle size of approximately 1 to approximately 1,000 microns and a melt index of approximately 50 to approximately 500 grams/10 minutes at 190° C. at a weight of 2.16 kg; and
wherein the polymer particles are applied to the primary backing at a rate of approximately 5 to approximately 18 ounces per square yard;
(b) heating the polymer particles on the primary backing and loop backs to a temperature at or above the melting temperature of the polymer particles; and
(c) allowing the heated polymer particles to cool below their melting temperature wherein the tufted synthetic turf has bundle lock of at least 6.8 pounds and the tufted synthetic turf has a water permeability of at least 10 inches of water per hour.

2. The method of claim 1, wherein the polymer particles are applied to the primary backing at a rate of approximately 8 to approximately 18 ounces per square yard.

3. The method of claim 1, wherein the polymer particles are applied to the primary backing at a rate of approximately 8 to approximately 13 ounces per square yard.

4. The method of claim 1, wherein the polymer particles are applied to the primary backing at a rate of approximately 5 to approximately 13 ounces per square yard.

5. The method of claim 1, wherein the polymer particles are applied to the primary backing at a rate of approximately 5 to approximately 8 ounces per square yard.

6. The method of claim 1, wherein the thermoplastic polymer particles of step (a) have a particle size of approximately 1 micron to approximately 100 microns.

7. The method of claim 1, wherein the thermoplastic polymer particles of step (a) have an average particle size of approximately 1 micron to approximately 80 microns.

8. The method of claim 1, wherein the aqueous dispersion of step (a) comprises:
approximately 50% to approximately 90% by weight water;
approximately 0.1% to approximately 10% by weight dispersion agent; and
approximately 20% to approximately 70% by weight thermoplastic polymer particles.

9. The method of claim 1, wherein the thermoplastic polymer particles of step (a) comprise polypropylene, polyethylene, thermoplastic polyester, polystyrene, polyvinylchloride, thermoplastic polyurethanes, thermoplastic copolymers thereof and mixtures thereof.

10. The method of claim 1, wherein the colloidal thermosetting polymer particles of step (b) are styrene butadiene (SBR), carboxylated styrene butadiene or vinyl acetate ethylene (VAE).

11. The method of claim 1, wherein the colloidal thermoplastic polymer particles of step (b) are high density polyethylene (HDPE), low density polyethylene (LDPE), polypropylene, ethylene acrylic acid or copolymers thereof.

12. The method of claim 1, wherein the second thermoplastic polymer particles of step (b) are high density polyethylene (HDPE), low density polyethylene (LDPE), linear low density polyethylene (LLDPE), polypropylene (PP), poly-vinyl chloride (PVC), ethylene-vinyl acetate (EVA), styrene ethylene butylene styrene (SEBS), poly(styrene-block-butadiene-block-styrene) (SBS), polyamide, acrylonitrile butadiene styrene (ABS), thermoplastic polyurethane (TPU), polylactic acid (PLA), ethyl methacrylate (EMA) or polyester.

13. The product of claim 1, wherein the colloidal thermosetting polymer particles or colloidal thermoplastic polymer particles of step (b) comprise about 5% to about 95% by weight and the second thermoplastic polymer particles of step (b) comprise about 5% to about 95% by weight based on the total weight of dry polymer.

14. The product of claim 1, wherein the second thermoplastic polymer particles of step (b) have an average particle size of approximately 400 micron to approximately 800 microns.

15. The method of claim 1, wherein the polyethylene polymer particles of step (c) has a melt index of approximately 150 to approximately 250 g/10 minutes at 190° C. at 2.16 kg.

16. The method of claim 1, wherein the polyethylene polymer particles of step (c) has a melt index of approximately 200 g/10 minutes at 190° C. at 2.16 kg.

17. The method of claim 1, wherein the polyethylene polymer particles of step (c) has a melting point of approximately 150 to approximately 250° F.

18. The method of claim 1, wherein the polyethylene polymer particles of step (c) has a melting point of approximately 200 to approximately 235° F.

19. The method of claim 1 further comprising applying a secondary backing material to the heated polymer particles on the primary backing and loop backs between steps (b) and (c).

20. A synthetic turf made by the process of claim 1.

21. A synthetic turf made by the process of claim 5.

22. A method comprising:
applying to a primary backing and loop backs of a tufted synthetic turf a plurality of solid polymer particles having a particle size of less than or equal to 1,000 microns such that a layer of solid polymer particles is formed across the width and length of the primary backing, wherein the polymer particles are applied to the primary backing at a rate of approximately 5 to approximately 18 ounces of polymer per square yard, and wherein the solid polymer particles are thermoplastic polymer particles or a mixture of thermoplastic polymer particles and thermosetting polymer particles;
heating the polymer particles on the primary backing and loop backs to a temperature at or above the melting temperature of the polymer particles; and
allowing the heated polymer particles to cool below their melting temperature wherein the tufted synthetic turf has bundle lock of at least 6.8 pounds and the tufted synthetic turf has a water permeability of at least 10 inches of water per hour.

23. The method of claim 22, wherein the polymer particles are applied to the primary backing at a rate of approximately 8 to approximately 18 ounces per square yard.

24. The method of claim 22, wherein the polymer particles are applied to the primary backing at a rate of approximately 8 to approximately 13 ounces per square yard.

25. The method of claim 22, wherein the polymer particles are applied to the primary backing at a rate of approximately 5 to approximately 13 ounces per square yard.

26. The method of claim 22, wherein the polymer particles are applied to the primary backing at a rate of approximately 5 to approximately 8 ounces per square yard.

27. The method of claim 22 further comprising applying a secondary backing material to the heated polymer particles on the primary backing and loop backs before the heated polymer particles are allowed to solidify.

28. A synthetic turf made by the process of claim 22.

29. A synthetic turf made by the process of claim 26.
